(19) United States
(12) Patent Application Publication
(10) Pub. No.: US 2020/0202843 A1
(43) Pub. Date: Jun. 25, 2020

(54) UNWANTED KEYWORD DETECTION ABATEMENT SYSTEMS AND METHODS

(71) Applicant: KNOWLES ELECTRONICS, LLC, Itasca, IL (US)

(72) Inventor: Pratik Shah, Mountain View, CA (US)

(21) Appl. No.: 16/720,125

(22) Filed: Dec. 19, 2019

Related U.S. Application Data
(60) Provisional application No. 62/784,108, filed on Dec. 21, 2018.

(51) Int. Cl. G10L 15/08; G06F 3/16; H04L 29/06; G06F 9/54

(52) U.S. Cl. CPC G10L 15/08; G06F 3/16; G10L 2015/088; G06F 9/542; H04L 65/601

(57) ABSTRACT

A system and method provides for unwanted keyword detection abatement. For instance, a playback signal corresponding to an output audio signal is received and checked for presence of a playback keyword. A blocking window is activated upon detection of the playback keyword. Based at least partially on the blocking window being activated, keywords present in an input audio signal are ignored because those keywords are likely to be included in the playback signal, rather than a genuine instruction from a user.

### CROSS-REFERENCE TO RELATED APPLICATIONS

This application claims the benefit of and priority to U.S. Provisional Patent Application No. 62/784,108, filed Dec. 21, 2018, the entire contents of which are incorporated herein by reference.

### TECHNICAL FIELD

This application relates generally to audio processing and more particularly to systems and methods for unwanted keyword detection abatement.

### BACKGROUND

A voice controlled user interface of a communication or other audio device may activate in response to a user speaking a keyword. However, the user may utilize the voice controlled user interface in a variety of different contexts, including contexts with reproduced sound including a same or similar keyword. The reproduced sound may include speech emitted by a speaker of the communication device. For example, a user may use a communication device to speak with a remote third party, or may use an audio device to listen to music or spoken word or other content. Both the user and the remote third party (or music or spoken word content) may, from time to time, speak keywords, to control their own communication device or simply as a part of the music or spoken word content. However, reproduction by the device of the speech containing the keyword spoken by the remote third party or music or spoken word content may problematically trigger the voice controlled user interface in response to the keyword. Thus there remain challenges associated with distinguishing sounds associated with voice control inputs of a user from other sounds such as reproduced sounds.

### BRIEF DESCRIPTION OF THE DRAWINGS

For a more complete understanding of the disclosure, reference should be made to the following detailed description and accompanying drawings wherein:

FIG. 1 depicts an example audio device including a host device and an audio device with an unwanted keyword detection abatement system therein, in accordance with various embodiments;

FIG. 2 depicts an example unwanted keyword detection abatement system, in accordance with various embodiments;

FIGS. 3A-C illustrate flow chart depicting methods of false keyword detection abatement, in accordance with various embodiments;

FIG. 4 illustrates a first example set of keyword detection events with a blocking window extending from a keyword detected in a playback signal forward in time, in accordance with various embodiments;

FIG. 5A illustrates a second example set of keyword detection events with a blocking window extending from a keyword detected in a playback signal back in time, in accordance with various embodiments; and

FIG. 5B illustrates a third example set of keyword detection events with a delay window extending from a keyword detected in the microphone signal, in accordance with various embodiments.

### SUMMARY

A method of unwanted keyword detection abatement is provided. The method may include receiving a playback signal corresponding to an output audio signal. The method may include determining whether a playback keyword is present in the received playback signal. A blocking window may be activated for a period of time in response to determining that the playback keyword is present in the received playback signal. A microphone signal may be received corresponding to an input audio signal. The method may include determining whether a microphone keyword is present in the microphone signal. Finally, notification of the microphone keyword being present may be inhibited if the determination that the microphone keyword is present in the microphone signal occurs during the period of time that the blocking window is activated.

The method may include other aspects. For example, notification may be provided that the microphone keyword is present in the microphone signal if the determination that the microphone keyword is present in the microphone signal occurs while the blocking window is not activated. In further instances, the playback keyword and the microphone keyword are the same keyword.

In various embodiments, the method includes additional steps. For instance, the method may include determining whether a second microphone keyword is present in the microphone signal and determining that the second microphone keyword is present in the microphone signal during the period of time that the blocking window is activated. The method may include permitting notification of the second microphone keyword being present, the permitting being in response to the second microphone keyword being a different keyword than the playback keyword.

The blocking window may include specific aspects. For instance, the blocking window may have a first duration of time beginning prior to a first time coinciding with the playback keyword being present in the received playback signal and ending at the first time coinciding with the playback keyword being present in the received playback signal. In further instances, the blocking window has a first duration of time beginning at a time coinciding with the playback keyword being present in the received playback signal and extending for the first duration of time thereafter.

The aspect of receiving the microphone signal may include further features. For instance, the receiving step may include accessing a signal buffer and loading stored data corresponding to the microphone signal at a past time temporally antecedent to the first time.

A non-transient computer readable medium is also contemplated. The computer readable medium may contain program instructions for causing a computer to perform a method of unwanted keyword detection abatement as described herein.

Similarly, a system of unwanted keyword detection abatement is provided. The system may include a variety of modules. For instance, the system may include a playback keyword detector to receive a playback signal corresponding to an output audio signal and determining whether a playback keyword is present in the received playback signal. The system may have a keyword presence window controller connected to the playback keyword detector and configured to activate, for a period of time, a blocking window in response to determining by the keyword presence window controller that the playback keyword is present in the received playback signal. A microphone signal enhancement module may be provided to receive a microphone signal corresponding to an input audio signal. A microphone keyword detector may be connected to the microphone signal enhancement module to determine whether a microphone keyword is present in the received microphone signal. Finally, there may be a keyword detection decision module connected to the microphone keyword detector and to the keyword presence window controller and configured to inhibit notification of the microphone keyword being present if the determination that the microphone keyword is present in the received microphone signal occurs during the period of time that the blocking window is activated.

In various embodiments, the keyword detection decision module further provides notification that the microphone keyword is present in the received microphone signal if the determination that the microphone keyword is present in the received microphone signal occurs while the blocking window is not activated.

In further embodiments, the microphone keyword detector further determines whether a second microphone keyword is present in the received microphone signal. The keyword detection decision module further determines that the second microphone keyword is present in the received microphone signal during the period of time that the blocking window is activated. The keyword detection decision module triggers an interrupt on an interrupt output including a notification of the second microphone keyword being present, the triggering being in response to the second microphone keyword being a different keyword than the playback keyword.

The blocking window may include a first duration of time beginning prior to a first time coinciding with the playback keyword being present in the received playback signal and ending at the first time coinciding with the playback keyword being present in the received playback signal. The blocking window may include a first duration of time beginning at a time coinciding with the playback keyword being present in the received playback signal and extending for the first duration of time thereafter.

The system may have additional aspects. These aspects may include wherein the keyword detection decision module has a signal buffer and the microphone signal corresponding to the input audio signal is stored in the signal buffer. The keyword detection decision module accesses the signal buffer and loads stored data corresponding to the microphone signal at a past time temporally antecedent to the first time to generate the received microphone signal.

Finally, a further method of unwanted keyword detection abatement is provided. The method may include receiving a microphone signal corresponding to an input audio signal and determining whether a microphone keyword is present in the microphone signal. The method may include activating, for a period of time, a delay window in response to determining that the microphone keyword is present in the microphone signal. Moreover, the method may include receiving a playback signal corresponding to an output audio signal, determining whether a playback keyword is present in the received playback signal, and inhibiting notification of the microphone keyword being present if the determination that the playback keyword is present in the playback signal occurs during the period of time that the delay window is activated.

The method may have other aspects. For instance, the method may include providing notification that the microphone keyword is present in the microphone signal if the determination that the playback keyword is present in the playback signal occurs while the delay window is not activated. In some instances, the playback keyword and the microphone keyword are the same keyword. Finally, the delay window may be a first duration of time beginning at a time coinciding with the microphone keyword being present in the microphone signal and extending for the first duration of time thereafter.

### DETAILED DESCRIPTION

Skilled artisans will appreciate that elements in the figures are illustrated for simplicity and clarity. It will further be appreciated that certain actions, blocks, and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

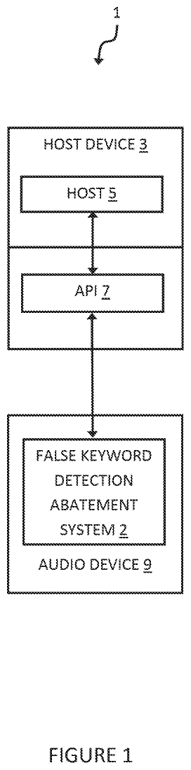

According to certain general aspects, the present embodiments are directed to systems and methods for unwanted keyword detection abatement. An unwanted keyword detection abatement system may be implemented to facilitate the abatement of unwanted keyword detection. Referring to FIG. 1, a voice assistance device 1 is shown. The voice assistance device 1 may have an audio device 9 with an unwanted keyword detection abatement system 2.

In various embodiments, the voice assistance device 1 may be a smart speaker and have a speaker and a microphone. The speaker and microphone may both be aspects of the audio device 9. In further instances, one of the speaker and microphone may be a part of a host device 3 and the other may be part of an audio device 9 connected via an API 7 to the host 5 running on the host device 3. In this manner, different configurations of hardware are contemplated. The speaker may reproduce sound for a user to hear. The microphone may receive sound produced by the user and other sound sources for electronic processing and/or transmission to a remote audio device operated by a third party. For example, the audio device 9 may be used for voice communication between individuals.

The voice assistance device 1 may have a host device 3, as mentioned. The host device 3 may include a computer, processor(s) or other electronic device as desired. The host device 3 includes one or more communication channels (e.g. WiFi, Bluetooth, etc.) to communicate with other devices remotely disposed away from the host device 3 or to receive music or spoken word content. For instance, the host device 3 may communicate with a user's mobile device to allow a user to have an audio or video call with another person far away via the mobile device and voice assistance device 1. The host device 3 thus may receive an audio input and may provide an audio output so that a user may both speak and listen. The host device 3 may include a host 5 that communicates via an API 7 with an audio device 9 providing at least one of the audio input and the audio output functionality.

An audio device 9 may include a speaker, a microphone, or any other input, output, or combination input and output device. For example, audio device 9 may have a microphone that is used by a user to control a voice activated user interface of the host 5. However, the microphone may also detect sounds from surrounding sources other than the user. These challenges are also present when the microphone detects sounds generated by the speaker of the audio device 9. An unwanted keyword detection abatement system 2 is thus incorporated into the audio device 9 to address this challenge. For instance, the audio device 9 having the unwanted keyword detection abatement system 2 may send a keyword detection and/or activation signal to an API 7 of a host device 3 so that a host 5 of the host device 3 takes a responsive action when a user speaks a keyword that controls a function of the host 5. The unwanted keyword detection abatement system 2 may also may inhibit the transmission of a keyword detection and/or activation signal to the API 7 when the detection of an unwanted keyword is desired to be ameliorated. For instance, in instances wherein the keyword is not user generated, but instead is a reproduced sound emitted by the audio device 9 or the host device 3 as a part of a conversation of the user with a third party or as part of any audio playback, the unwanted keyword detection abatement system 2 may inhibit the transmission of a keyword detection and/or activation signal to the API 7 because the keyword is not originating from the local user, but is reproduced and emitted by the speaker based on speech of a third party or as a part of any audio playback.

In one non-limiting embodiment shown in FIG. 1 and briefly discussed above, the voice assistance device 1 may comprise a smart speaker. However, voice assistance device 1 may alternatively comprise a smartphone, a laptop, a tablet, or another electronic device. The host 5 of the host device 3 may comprise a software application and/or a processor executing software instructions from a memory. The host 5 may communicate via the API 7 with the audio device 9. The audio device 9 may comprise a smart microphone (i.e. a single module incorporating both a microphone and a processor such as an ASIC and/or a DSP). The smart microphone may include an unwanted keyword detection abatement system 2 (e.g., implemented by the processor and associated firmware). The audio device 9 may also include a speaker to reproduce sound at the direction of the host 5, though in further embodiments, the speaker is a part of the host device 3 itself. Thus one may appreciate that a host device 3 may wait to receive a keyword or other voice command. The audio device 9 may cause a state transition of the host device 3 when a keyword is received. For instance, the host device 3 may awaken and become ready to receive further instructions or may take action based on the keyword itself. The audio device 9 communicates with the host device 3 via a signal sent to the API 7 from the unwanted keyword detection abatement system 2. For instance, voice assistance device 1 may enter a sleep state until the smart microphone causes the device to awaken from the sleep state. The smart microphone may cause this awakening in response to a detection event associated with the unwanted keyword detection abatement system 2, such as detection of a spoken keyword uttered by a user.

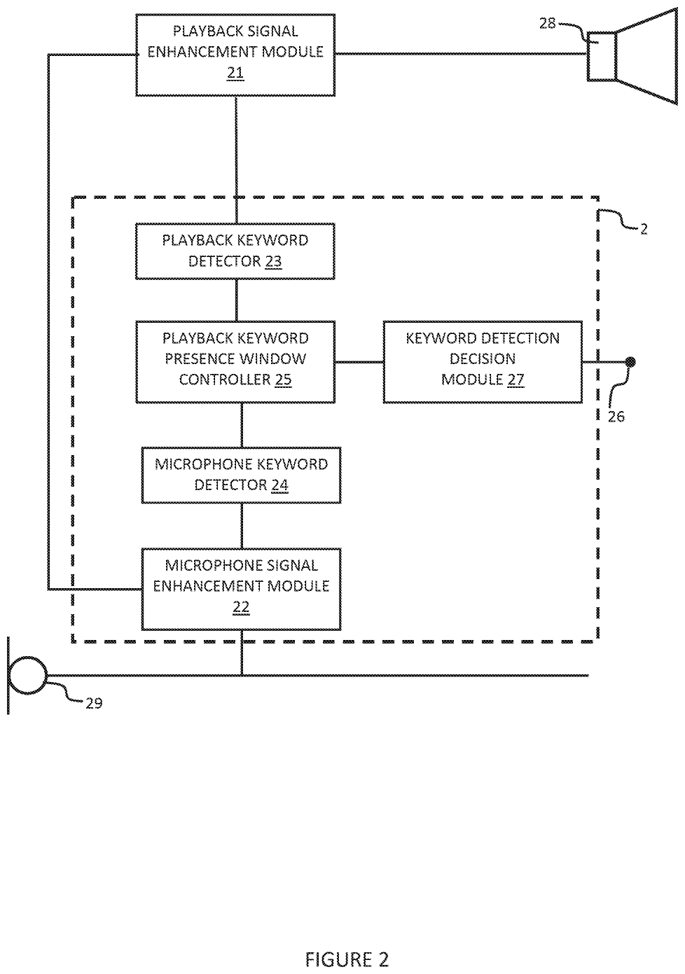

In FIG. 2, an example embodiment of an unwanted keyword detection abatement system 2 is depicted. An unwanted keyword detection abatement system 2 may include a playback signal keyword detector 23 that receives a playback signal corresponding to an output signal from a playback signal enhancement module 21. The output audio signal may correspond to audio for emission by a speaker 28. For instance, a speaker 28 may be part of the host device 3 (FIG. 1) or part of the audio device 9 (FIG. 1). The speaker 28 may reproduce audio for listening by a user.

The playback signal enhancement module 21 may comprise a processor and/or application configured to process the playback signal for interpretation by the unwanted keyword detection abatement system 2. For example, the playback signal enhancement module 21 may process the playback signal by (1) changing time-domain and/or frequency-domain characteristics of the output audio signal, (2) sampling or otherwise performing analog-to-digital conversion operations on the output audio signal, and/or (3) filtering the output audio signal to facilitate detection of keywords in the received playback signal after the processing is performed. The playback signal enhancement module 21 may be connected to a playback keyword detector 23 and may process the playback signal and provide the received playback signal after processing to the playback keyword detector 23.

The playback keyword detector 23 may comprise a common or additional processor and/or application configured to determine whether a playback keyword is present in the received playback signal. For example, the playback keyword detector 23 may analyze one or more samples of the received playback signal and determine whether the contents of that signal correspond to sounds forming a keyword. A keyword may comprise a spoken phrase and/or a tone. A keyword may include “Alexa” or “Siri” or “Hey Google” or any other keyword. The playback keyword detector 23 may trigger a keyword presence interrupt when a keyword is detected. The keyword presence interrupt may be caught by a keyword presence window controller 25 which may take responsive action.

The unwanted keyword detection abatement system 2 may include a microphone signal enhancement module 22. The microphone signal enhancement module 22 may receive a microphone signal corresponding to an input audio signal. The input audio signal may correspond to audio from a microphone 29 that receives sound inputs from a user. For instance, a microphone 29 may be part of the host device 3 (FIG. 1) or part of the audio device 9 (FIG. 1). The microphone 29 may receive voice command inputs from a user. However, the microphone 29 may also receive acoustic echo from the speaker 28, including sounds that are played by the speaker 28 that may correspond to a voice command such as a keyword. Thus, the unwanted keyword detection abatement system 2 operates to abate the effects of these unwanted voice commands such as unwanted keywords originating from the received playback signal.

The microphone signal enhancement module 22 may comprise a processor and/or application configured to process the microphone signal for interpretation by other aspects of the unwanted keyword detection abatement system 2. For example, the microphone signal enhancement module 22 may process the microphone signal by (1) changing time-domain and/or frequency-domain characteristics of the microphone audio signal, (2) sampling or otherwise performing analog-to-digital conversion operations on the output audio signal, and/or (3) filtering the microphone audio signal to facilitate detection of keywords in the microphone after the processing is performed. The microphone signal enhancement module 22 may perform other processing such as noise suppression, echo cancellation, etc.

The microphone signal enhancement module 22 may be connected to the microphone keyword detector 24 and may process the microphone signal and provide the processed microphone signal after processing to the microphone keyword detector 24. In various embodiments, the microphone signal enhancement module 22 may also receive a playback signal corresponding to output audio. In this manner, the microphone signal enhancement module 22 may perform acoustic echo cancelation and other differencing operations or other signal processing operations to reduce acoustic echo wherein the playback signal is transduced by the microphone 29 to form a portion of a microphone signal.

The microphone keyword detector 24 may comprise a common or additional processor and/or application configured to determine whether a microphone keyword is present in the microphone signal. For example, the microphone keyword detector 24 may analyze one or more samples of the microphone signal and determine whether the contents of that signal correspond to sounds forming a keyword. For example, a keyword may comprise a spoken phrase and/or a tone. A keyword may include “Alexa” or “Siri” or “Hey Google.” The microphone keyword detector 24 may trigger a microphone keyword presence interrupt corresponding to detection of a keyword. The microphone keyword presence interrupt may be caught by the keyword detection decision module 27 which may take responsive action. The microphone keyword detector 24 may indicate to a keyword detection decision module 27 that a keyword is present via the throwing and catching of the keyword presence interrupt. In various embodiments separate microphone keyword presence interrupts and playback keyword presence interrupts make up the keyword presence interrupt. In further embodiments, a shared keyword presence interrupt is triggered by the microphone keyword detector 24 and the playback keyword detector 23.

With reference to FIGS. 2, 4, and 5A, a keyword presence window controller 25 is provided. The keyword presence window controller 25 may activate, for a period of time, a blocking window 408 in response to determining by the playback keyword detector 23 that the playback keyword 406 is present in the received playback signal 402. More specifically, the keyword presence window controller 25 is connected to a keyword detection decision module 27 that receives from the keyword presence window controller 25 an indication of whether a blocking window 408 is open or closed. The keyword detection decision module 27 has another input connected to a microphone signal 404. On this other input, further keyword detections are indicated (microphone keyword detection events 414, 418, 504, 506 from a microphone keyword detector 24). The keyword detection decision module 27 selectively ignores microphone keyword detection events 414, 504 and selectively takes action in response to these microphone keyword detection events 506, 418, depending at least in part on whether the blocking window 408 is open or closed at the time of the microphone keyword detection event.

The keyword presence window controller 25 may activate, for a period of time, the blocking window 408 by setting an output to a first state (e.g., Hi, Lo, Hi-Z) or indicating by a specific byte, series of bytes, function call, and/or the like, that a blocking window 408 is open. In other words, the keyword presence window controller 25 sets a blocking window status (e.g., opening edge 410 of blocking window 408). Upon the expiration of the period of time 416, the keyword presence window controller 25 may set the blocking window status to a second state that indicates that the blocking window is no longer open (e.g., closing edge 412 of blocking window 408). This second state is a different state than the first state. In this manner, the keyword presence window controller 25 instructs the keyword detection decision module 27 of the state of the blocking window 408.

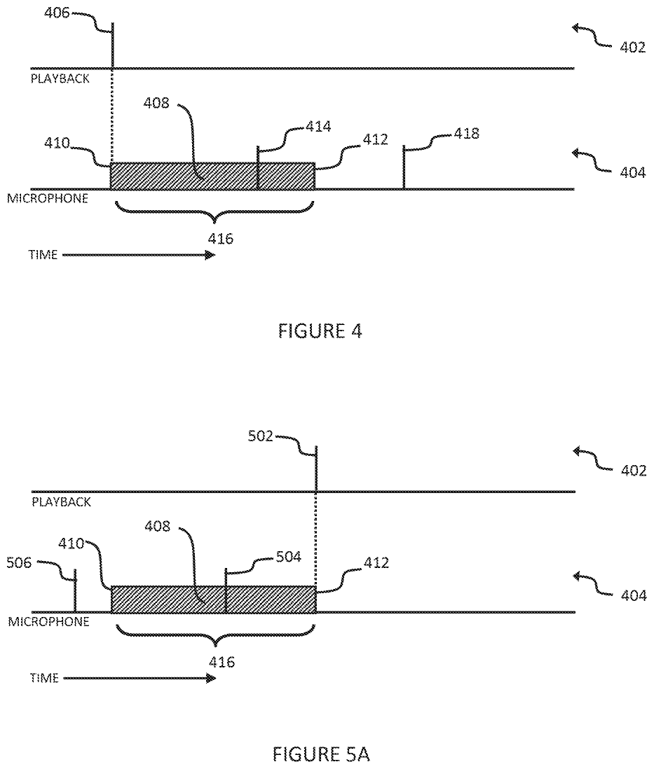

The blocking window can extend forward in time for the duration of time 416 upon activation (see FIG. 4). For instance, the keyword presence window controller 25 may activate, for a period of time 416, a blocking window 408 in response to determining by the playback keyword detector 23 that a playback keyword 406 is present in the received playback signal 402. Thereafter, the keyword detection decision module 27 inhibits notification of the microphone keyword 414 being present. Stated differently, any microphone keyword 414 detection event from a microphone keyword detector 24 that occurs during the blocking window 408, of a microphone keyword that is the same keyword as the playback keyword 406 is blocked.

However, the blocking window 408 can also extend back in time in response to determining by the playback keyword detector 23 that a playback keyword is present 502 for the duration of time 416 upon activation. For instance, due to various processing delays, a microphone keyword 504 desired to be blocked may appear to occur earlier in time than the playback keyword 502, even though the microphone keyword 504 is the real-world detection by a microphone of the audio generated by a speaker playing the playback keyword 502. Thus, one may appreciate that the playback signal 402 (and/or the microphone signal 404) may be buffered, to facilitate this retroactive blocking. In various embodiments, the blocking window 408 comprises a first duration of time 416 beginning prior to a first time coinciding with the playback keyword being present in the received playback signal (e.g., opening edge 410 of blocking window 408) and ending at the first time (e.g., closing edge 412 of the blocking window 408) coinciding with the playback keyword 502 being present in the received playback signal 402. Yet another way to facilitate this retroactive blocking is to continuously buffer the microphone signal so that even in scenarios wherein a microphone keyword 504 is after the corresponding playback keyword 502, the FIG. 4 representation depicts the time-delayed relationship of the microphone signal 404 (after time shifting) to the playback signal 402.

As mentioned, buffers may be implemented to facilitate this retroactive blocking. For instance, the keyword detection decision module 27 may include a signal buffer. The microphone signal corresponding to the input audio signal may be stored in the signal buffer. The keyword detection decision module 27 may access the signal buffer and load stored data corresponding to the microphone signal 404 at a past time temporally antecedent to the first time (e.g., the time the playback keyword 502 is detected). Thus, receiving the microphone signal 404 comprises accessing a signal buffer and loading stored data corresponding to the microphone signal 404 at a past time temporally antecedent to the first time (e.g., the time the playback keyword 502 is detected). By delaying the microphone signal 404 in a buffer, a later-detected playback keyword 502 may precipitate the inhibiting of notification of an earlier-detected microphone keyword 504.

Finally, a keyword detection decision module 27 is provided. The keyword detection decision module 27 comprises a processor and/or application that receives the blocking window status from the keyword presence window controller 25. The keyword detection decision module 27 also catches the microphone keyword presence interrupt triggered by the microphone keyword detector 24. The keyword detection decision module 27 may be configured to inhibit notification of the microphone keyword being present if the determination that the microphone keyword is present in the microphone signal occurs during the period of time that the blocking window is activated. In various instances, the keyword detection decision module 27 also checks whether the microphone keyword and the playback keyword that triggered the blocking window are the same keyword. For instance, in various instances the notification is inhibited only if the keywords are the same and the microphone keyword is within the blocking window. While the keyword detection decision module 27 may check whether the microphone keyword and the playback keyword are the same keyword, in further instances, multiple keyword detection modules (one per keyword) are implemented so that the keyword is identifiable based on which keyword detection module has been triggered.

For example, in response to processing both the blocking window status and the microphone keyword presence interrupt, the keyword detection decision module 27 sets a keyword trigger status on a keyword trigger status output 26. The keyword trigger status may comprise an interrupt, or may comprise setting an output to a state (e.g., Hi, Lo, Hi-Z), or indicating by a specific byte, series of bytes, function call, and/or the like. The keyword trigger status may include triggering an interrupt on an interrupt output (keyword trigger status output 26). The keyword trigger status may indicate that a microphone keyword is present in the microphone signal. However, the keyword trigger status may continue to indicate that a microphone keyword is not present in the microphone signal, even if such a keyword is present in the microphone signal, in response to the blocking window status indicating that the microphone keyword is present in the microphone signal during the period of time that the blocking window is activated. In this manner, the blocking window may be said to “block” indication of the presence of the microphone keyword in the microphone signal.

Moreover, the keyword detection decision module 27 may provide a keyword trigger status comprising notification that the microphone keyword is present in the microphone signal if the determination that the microphone keyword is present in the microphone signal occurs while the blocking window is not activated. For instance, the microphone keyword may be present in the microphone signal prior to the activation of the blocking window. In further instances, the microphone keyword may be present in the microphone signal after the period of time that the blocking window is activated has expired.

While the discussion above is with respect to a single microphone keyword, in some scenarios, multiple microphone keywords may be detected. For instance, the keyword detection decision module 27 may provide different keyword trigger statuses associated with different of the detected multiple microphone keywords. The microphone keyword detector 24 further determines whether a second microphone keyword is present in the received microphone signal. The keyword detection decision module 27 further determines that the second microphone keyword is present in the received microphone signal during the period of time that the blocking window is activated. In such a scenario, the keyword detection decision module 27 triggers an interrupt on an interrupt output comprising a notification of the second microphone keyword being present, the triggering being in response to the second microphone keyword being a different keyword than the playback keyword. In this instance, the coincidence of the second microphone keyword with the blocking window does not lead to the inhibiting of the blocking window, because the keyword detection decision module 27 determines that the microphone keyword and the playback keyword are different keywords.

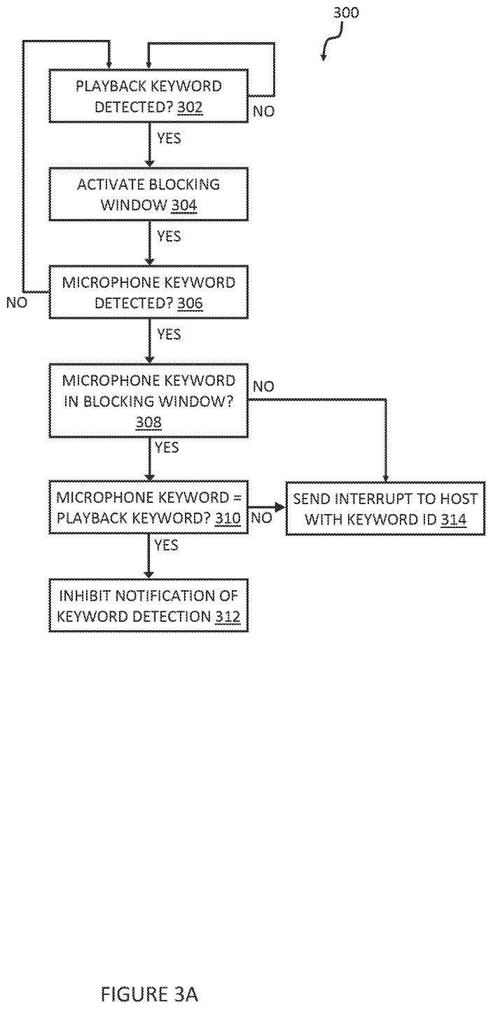

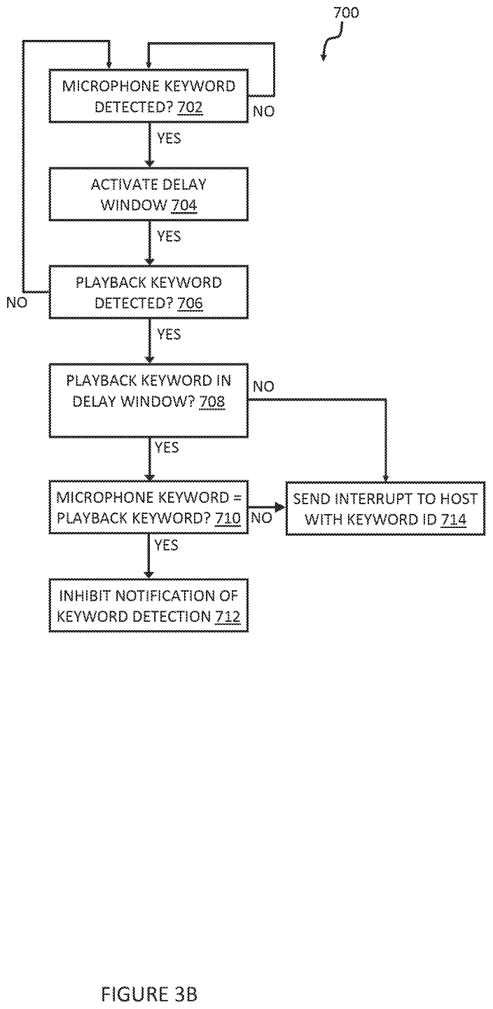

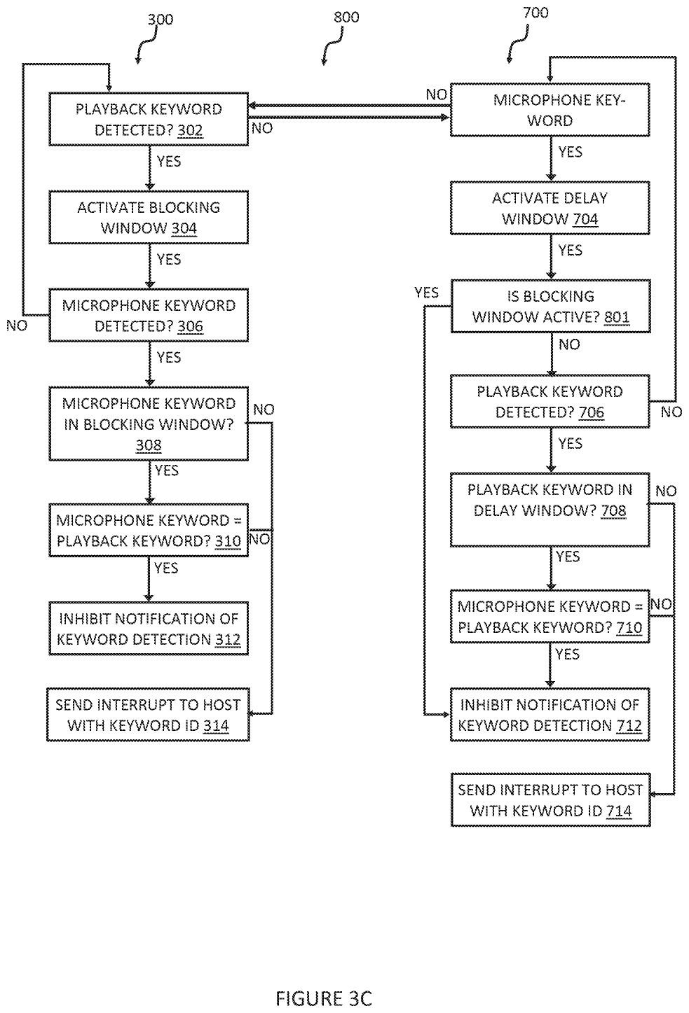

With reference to FIG. 3A, a method of unwanted keyword detection abatement 300 is illustrated in an example flow chart. While the specific steps of the method have already been discussed in parallel with the discussion of the system of unwanted keyword detection abatement, brief reference to FIG. 3 is useful to demonstrate one example implementation of the sequence in which the discussed aspects are performed. For instance, a method of unwanted keyword detection abatement may include receiving a playback signal corresponding to an output audio signal and determining whether a playback keyword is present in the received playback signal (block 302). In response to a playback keyword not being detected, the method remains at block 302. In response to the playback keyword being detected, a blocking window is activated for a period of time (block 304). A microphone signal corresponding to an input audio signal is received and it is determined whether a microphone keyword is present in the microphone signal (block 306). In response to no microphone keyword being detected, the method returns to block 302. In response to a microphone keyword being detected, it is determined whether the microphone keyword is within the blocking window (block 308). In response to the microphone keyword being not within the blocking window, an interrupt is sent to the host to indicate that a keyword has been detected. In various instances the interrupt also includes an identification of the specific keyword detected, such as when multiple keywords are possible (block 314). In response to the microphone keyword being within the blocking window, the microphone keyword is compared to the playback keyword (block 310). Again, the method proceeds to block 314 if the microphone keyword is not the same keyword as the playback keyword. On the other hand, if the microphone keyword is the same as the playback keyword, then notification of the microphone keyword being present is inhibited (block 312).

With reference to FIGS. 2, 4, and 5B, a further embodiment of a provided keyword presence window controller 25 is disclosed. The keyword presence window controller 25 may, in addition to or in lieu of, activating a blocking window, may activate a delay window. More specifically, the keyword presence window controller 25 may activate, for a period of time 616, a delay window 608 in response to determining by the microphone keyword detector 24 that the microphone keyword 506, 504 is present in the microphone signal 404. More specifically, the keyword presence window controller 25 is connected to a keyword detection decision module 27 that receives from the keyword presence window controller 25 an indication of whether a delay 608 is open (depicted by opening edge 610) or closed (depicted by closing edge 612). The keyword detection decision module 27 has another input connected to the playback keyword detector 23 to receive a received playback signal 402. On this other input, further keyword detection(s) are indicated (keyword detection event 502 from a playback keyword detector 23). The keyword detection decision module 27 selectively ignores microphone keyword detection event 504 in response to the playback keyword detection event 502 falling within the delay window 608 opened (see opening edge 610) by the microphone keyword detection event 504. This is because it can be assumed that the microphone keyword detection event 504 is associated with an unwanted keyword overheard by the microphone and corresponding to the playback keyword detection event 502—albeit with a processing delay that causes the playback keyword detection event 502 to be detected after the microphone keyword detection event 504. In this manner, the system 2 delays taking action based on microphone keyword detection events, until after it is determined whether a playback keyword detection event falls within a period of time following the microphone keyword detection event. Such a playback keyword detection event is likely responsible for the microphone keyword detection event, though a processing delay causes the playback keyword detection event to appear to be later occurring. On the other hand, the keyword detection decision module 27 may selectively take action in response to microphone keyword detection event 506, because no playback keyword detection event falls within the blocking window 608 opened thereafter. Thus, action is selectively taken depending at least in part on whether the delay window 608 is open or closed at the time of the playback keyword detection event.

The keyword presence window controller 25 may activate, for a period of time, the delay window 608 by setting an output to a first state (e.g., Hi, Lo, Hi-Z) or indicating by a specific byte, series of bytes, function call, and/or the like, that a blocking window 408 is open. In other words, the keyword presence window controller 25 sets a delay window status (e.g., opening edge 610 of delay window 608). Upon the expiration of the period of time 616, the keyword presence window controller 25 may set the delay window status to a second state that indicates that the delay window is no longer open (e.g., closing edge 612 of delay window 608). This second state is a different state than the first state. In this manner, the keyword presence window controller 25 instructs the keyword detection decision module 27 of the state of the delay window 608.

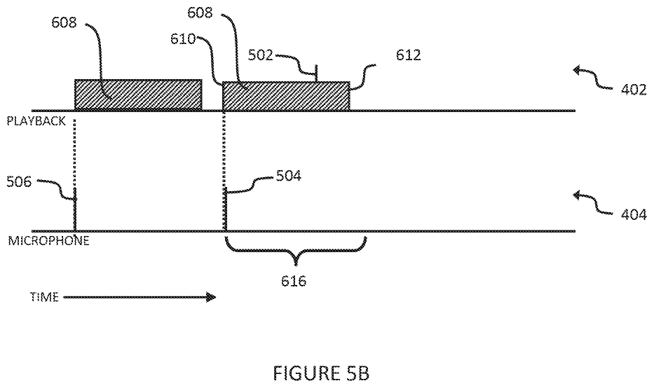

The blocking window can extend forward in time for the duration of time 616 upon activation (see FIG. 5B). For instance, the keyword presence window controller 25 may activate, for a period of time 616, a delay window 608 in response to determining by the microphone keyword detector 24 that a microphone keyword 504, 506 is present in the microphone signal 404. Thereafter, the keyword detection decision module 27 inhibits notification of the microphone keyword 504 being present until after the delay window has closed without any detection of a playback keyword detection event 502 therein. Stated differently, any playback keyword detection event from a playback keyword detector 23 that occurs during the delay window 608, of a playback keyword that is the same keyword as the microphone keyword 504 causes detection of the microphone keyword 504 to be inhibited (e.g., “blocked).

Attention is now redirected to the keyword detection decision module 27 to discuss additional aspects with reference to the delay window introduced above. The keyword detection decision module 27 comprises a processor and/or application that receives the delay window status from the keyword presence window controller 25. The keyword detection decision module 27 also catches the playback keyword presence interrupt triggered by the playback keyword detector 23. The keyword detection decision module 27 may be configured to inhibit notification of the microphone keyword being present if the determination that the microphone keyword is present in the microphone signal occurs no more than one delay window 608 period of time 616 prior to a determination that the playback keyword is present in the playback signal. In various instances, the keyword detection decision module 27 also checks whether the playback keyword and the microphone keyword that triggered the delay window are the same keyword. For instance, in various instances the notification is inhibited only if the keywords are the same. While the keyword detection decision module 27 may check whether the microphone keyword and the playback keyword are the same keyword, in further instances, multiple keyword detection modules (one per keyword) are implemented so that the keyword is identifiable based on which keyword detection module has been triggered.

For example, in response to processing both the delay window status and the playback keyword presence interrupt, the keyword detection decision module 27 sets a keyword trigger status on a keyword trigger status output 26. The keyword trigger status may comprise an interrupt, or may comprise setting an output to a state (e.g., Hi, Lo, Hi-Z), or indicating by a specific byte, series of bytes, function call, and/or the like. The keyword trigger status may include triggering an interrupt on an interrupt output (keyword trigger status output 26). The keyword trigger status may indicate that a microphone keyword is present in the microphone signal. However, the keyword trigger status may continue to indicate that a microphone keyword is not present in the microphone signal, even if such a keyword is present in the microphone signal, in response to the delay window status indicating that the playback keyword is present in the received playback signal during the period of time that the delay window is activated. In this manner, the delay window may be said to “block” indication of the presence of the microphone keyword in the microphone signal, because a playback keyword appeared in the playback signal during the period of time that the delay window is activated.

Moreover, the keyword detection decision module 27 may provide a keyword trigger status comprising notification that the microphone keyword is present in the microphone signal if a determination that the playback keyword is present in the microphone signal does not occur while the delay window is activated. For instance, the microphone keyword may be present in the microphone signal and may open a delay window. No playback keyword becomes present during the delay window. Thus, the microphone keyword is associated with a keyword trigger status comprising notification that the microphone keyword is present in the microphone signal.

While the discussion above is with respect to a single keyword, in some scenarios, multiple keywords may be detected. For instance, the keyword detection decision module 27 may provide different keyword trigger statuses associated with different of the detected multiple microphone keywords. For example, if the playback keyword detected during the delay window is not the same keyword as the microphone keyword that triggered the delay window, then the microphone keyword may be a valid detection event and the keyword detection decision module 27 triggers an interrupt on an interrupt output comprising a notification of the microphone keyword being present, the triggering being in response to the microphone keyword being a different keyword than the playback keyword. In this instance, the coincidence of the playback keyword with the delay window does not lead to the inhibiting of the microphone keyword, because the keyword detection decision module 27 determines that the microphone keyword and the playback keyword are different keywords.

With reference to FIG. 3B, a method of unwanted keyword detection abatement 700 is illustrated in an example flow chart. While the specific steps of the method have already been discussed in parallel with the discussion of the system of unwanted keyword detection abatement, brief reference to FIG. 3B is useful to demonstrate one example implementation of the sequence in which the discussed aspects are performed. For instance, a method of unwanted keyword detection abatement may include receiving a microphone signal corresponding to an input audio signal and determining whether a microphone keyword is present in the microphone signal (block 702). In response to a microphone keyword not being detected, the method remains at block 302. In response to the microphone keyword being detected, a delay window is activated for a period of time (block 704). A playback signal corresponding to an output audio signal is received and it is determined whether a playback keyword is present in the playback signal (block 706). In response to no playback keyword being detected, the method returns to block 702. In response to a playback keyword being detected, it is determined whether the playback keyword is within the delay window (block 708). In response to the playback keyword being not within the delay window, an interrupt is sent to the host to indicate that a keyword has been detected. In various instances the interrupt also includes an identification of the specific keyword detected, such as when multiple keywords are possible (block 714). In response to the playback keyword being within the delay window, the microphone keyword is compared to the playback keyword (block 710). Again, the method proceeds to block 714 if the microphone keyword is not the same keyword as the playback keyword. On the other hand, if the microphone keyword is the same as the playback keyword, then notification of the microphone keyword being present is inhibited (block 712).

Finally, with reference to FIG. 3C, a combination method of unwanted keyword detection abatement 800 is illustrated in an example flow chart. The method 300 of FIG. 3A and the method 700 of FIG. 3B are combined as depicted. While the specific steps of the method have already been discussed in parallel with the discussion of the system of unwanted keyword detection abatement, brief reference to FIG. 3C is useful to demonstrate another example implementation of the sequence in which the discussed aspects are performed.

For instance, a combination method of unwanted keyword detection abatement 800 may include receiving a playback signal corresponding to an output audio signal and determining whether a playback keyword is present in the received playback signal (block 302). In response to a playback keyword not being detected, the method proceeds to block 702. In response to the playback keyword being detected, a blocking window is activated for a period of time (block 304). A microphone signal corresponding to an input audio signal is received and it is determined whether a microphone keyword is present in the microphone signal (block 306). In response to no microphone keyword being detected, the method returns to block 302. In response to a microphone keyword being detected, it is determined whether the microphone keyword is within the blocking window (block 308). In response to the microphone keyword being not within the blocking window, an interrupt is sent to the host to indicate that a keyword has been detected. In various instances the interrupt also includes an identification of the specific keyword detected, such as when multiple keywords are possible (block 314). In response to the microphone keyword being within the blocking window, the microphone keyword is compared to the playback keyword (block 310). Again, the method proceeds to block 314 if the microphone keyword is not the same keyword as the playback keyword. On the other hand, if the microphone keyword is the same as the playback keyword, then notification of the microphone keyword being present is inhibited (block 312).

Turning focus now to block 702, the method 800 may also include receiving a microphone signal corresponding to an input audio signal and determining whether a microphone keyword is present in the microphone signal (block 702). In response to a microphone keyword not being detected, the method proceeds to block 302. In response to the microphone keyword being detected, a delay window is activated for a period of time (block 704). If a blocking window (see block 304) is also active (block 801) then, the method proceeds to block 712. Otherwise, a playback signal corresponding to an output audio signal is received and it is determined whether a playback keyword is present in the playback signal (block 706). In response to no playback keyword being detected, the method returns to block 702. In response to a playback keyword being detected, it is determined whether the playback keyword is within the delay window (block 708). In response to the playback keyword being not within the delay window, an interrupt is sent to the host to indicate that a keyword has been detected. In various instances the interrupt also includes an identification of the specific keyword detected, such as when multiple keywords are possible (block 714). In response to the playback keyword being within the delay window, the microphone keyword is compared to the playback keyword (block 710). Again, the method proceeds to block 714 if the microphone keyword is not the same keyword as the playback keyword. On the other hand, if the microphone keyword is the same as the playback keyword, then notification of the microphone keyword being present is inhibited (block 712).

As used herein, the singular terms “a,” “an,” and “the” may include plural references unless the context clearly dictates otherwise. Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

1. A method of unwanted keyword detection abatement comprising:
receiving a playback signal corresponding to an output audio signal;
determining whether a playback keyword is present in the received playback signal;
activating, for a period of time, a blocking window in response to determining that the playback keyword is present in the received playback signal;
receiving a microphone signal corresponding to an input audio signal;
determining whether a microphone keyword is present in the microphone signal; and
inhibiting notification of the microphone keyword being present if the determination that the microphone keyword is present in the microphone signal occurs during the period of time that the blocking window is activated.

2. The method of claim 1, further comprising providing notification that the microphone keyword is present in the microphone signal if the determination that the microphone keyword is present in the microphone signal occurs while the blocking window is not activated.

3. The method of claim 1, wherein the playback keyword and the microphone keyword are the same keyword.

4. The method of claim 1, further comprising:
determining whether a second microphone keyword is present in the microphone signal;
determining that the second microphone keyword is present in the microphone signal during the period of time that the blocking window is activated; and,
permitting notification of the second microphone keyword being present, the permitting being in response to the second microphone keyword being a different keyword than the playback keyword.

5. The method of claim 1, wherein the blocking window comprises a first duration of time beginning prior to a first time coinciding with the playback keyword being present in the received playback signal and ending at the first time coinciding with the playback keyword being present in the received playback signal.

6. The method of claim 5,
wherein the receiving the microphone signal comprises accessing a signal buffer and loading stored data corresponding to the microphone signal at a past time temporally antecedent to the first time.

7. The method of claim 1, wherein the blocking window comprises a first duration of time beginning at a time coinciding with the playback keyword being present in the received playback signal and extending for the first duration of time thereafter.

8. A non-transient computer readable medium containing program instructions for causing a computer to perform a method of unwanted keyword detection abatement comprising:
receiving a playback signal corresponding to an output audio signal;
determining whether a playback keyword is present in the received playback signal;
activating, for a period of time, a blocking window in response to determining that the playback keyword is present in the received playback signal;
receiving a microphone signal corresponding to an input audio signal;
determining whether a microphone keyword is present in the microphone signal; and
inhibiting notification of the microphone keyword being present if the determination that the microphone keyword is present in the microphone signal occurs during the period of time that the blocking window is activated.

9. The non-transient computer readable medium of claim 8, containing program instructions for causing the computer to perform the method of unwanted keyword detection abatement further comprising providing notification that the microphone keyword is present in the microphone signal if the determination that the microphone keyword is present in the microphone signal occurs while the blocking window is not activated.

10. The non-transient computer readable medium of claim 8, containing program instructions for causing the computer to perform the method of unwanted keyword detection abatement, wherein the playback keyword and the microphone keyword are the same keyword.

11. The non-transient computer readable medium of claim 8, containing program instructions for causing the computer to perform the method of unwanted keyword detection abatement further comprising:
determining whether a second microphone keyword is present in the microphone signal;
determining that the second microphone keyword is present in the microphone signal during the period of time that the blocking window is activated; and,
permitting notification of the second microphone keyword being present, the permitting being in response to the second microphone keyword being a different keyword than the playback keyword.

12. The non-transient computer readable medium of claim 8, containing program instructions for causing the computer to perform the method of unwanted keyword detection abatement,
wherein the blocking window comprises a first duration of time beginning prior to a first time coinciding with the playback keyword being present in the received playback signal and ending at the first time coinciding with the playback keyword being present in the received playback signal.

13. The non-transient computer readable medium of claim 12, containing program instructions for causing the computer to perform the method of unwanted keyword detection abatement,
wherein the receiving the microphone signal comprises accessing a signal buffer and loading stored data corresponding to the microphone signal at a past time temporally antecedent to the first time.

14. The non-transient computer readable medium of claim 8, containing program instructions for causing the computer to perform the method of unwanted keyword detection abatement,
wherein the blocking window comprises a first duration of time beginning at a time coinciding with the playback keyword being present in the received playback signal and extending for the first duration of time thereafter.

15. A system of unwanted keyword detection abatement comprising:
a playback keyword detector to receive a playback signal corresponding to an output audio signal and determining whether a playback keyword is present in the received playback signal;
a keyword presence window controller connected to the playback keyword detector and configured to activate, for a period of time, a blocking window in response to determining by the keyword presence window controller that the playback keyword is present in the received playback signal;
a microphone signal enhancement module to receive a microphone signal corresponding to an input audio signal;
a microphone keyword detector connected to the microphone signal enhancement module to determine whether a microphone keyword is present in the received microphone signal; and
a keyword detection decision module connected to the microphone keyword detector and to the keyword presence window controller and configured to inhibit notification of the microphone keyword being present if the determination that the microphone keyword is present in the received microphone signal occurs during the period of time that the blocking window is activated.

16. The system of claim 15, wherein the keyword detection decision module further provides notification that the microphone keyword is present in the received microphone signal if the determination that the microphone keyword is present in the received microphone signal occurs while the blocking window is not activated.

17. The system of claim 15, wherein the microphone keyword detector further determines whether a second microphone keyword is present in the received microphone signal;
wherein the keyword detection decision module further determines that the second microphone keyword is present in the received microphone signal during the period of time that the blocking window is activated; and,
wherein the keyword detection decision module triggers an interrupt on an interrupt output comprising a notification of the second microphone keyword being present, the triggering being in response to the second microphone keyword being a different keyword than the playback keyword.

18. The system of claim 15, wherein the blocking window comprises a first duration of time beginning prior to a first time coinciding with the playback keyword being present in the received playback signal and ending at the first time coinciding with the playback keyword being present in the received playback signal.

19. The system of claim 18,
wherein the keyword detection decision module comprises a signal buffer, wherein the microphone signal corresponding to the input audio signal is stored in the signal buffer,
wherein the keyword detection decision module accesses the signal buffer and loads stored data corresponding to the microphone signal at a past time temporally antecedent to the first time to generate the received microphone signal.

20. The system of claim 15, wherein the blocking window comprises a first duration of time beginning at a time coinciding with the playback keyword being present in the received playback signal and extending for the first duration of time thereafter.

21. A method of unwanted keyword detection abatement comprising:
receiving a microphone signal corresponding to an input audio signal;
determining whether a microphone keyword is present in the microphone signal; and
activating, for a period of time, a delay window in response to determining that the microphone keyword is present in the microphone signal;
receiving a playback signal corresponding to an output audio signal;
determining whether a playback keyword is present in the received playback signal; and
inhibiting notification of the microphone keyword being present if the determination that the playback keyword is present in the playback signal occurs during the period of time that the delay window is activated.

22. The method of claim 21, further comprising providing notification that the microphone keyword is present in the microphone signal if the determination that the playback keyword is present in the playback signal occurs while the delay window is not activated.

23. The method of claim 21, wherein the playback keyword and the microphone keyword are the same keyword.

24. The method of claim 21, wherein the delay window comprises a first duration of time beginning at a time coinciding with the microphone keyword being present in the microphone signal and extending for the first duration of time thereafter.
